(19) United States
(12) Patent Application Publication
(10) Pub. No.: US 2022/0112761 A1
(43) Pub. Date: Apr. 14, 2022

(54) Skateboard Storage Assembly

(71) Applicants: Paul Rodriguez, San Jose, CA (US); Desiree Rodriguez, San Jose, CA (US)

(72) Inventors: Paul Rodriguez, San Jose, CA (US); Desiree Rodriguez, San Jose, CA (US)

(21) Appl. No.: 17/066,627

(22) Filed: Oct. 9, 2020

(51) Int. Cl. E05G 1/08; A47B 49/00; E05G 1/04; E05B 65/00

(52) U.S. Cl. CPC E05G 1/08; A47B 49/002; G06Q 20/18; E05G 1/04; E05B 65/0075; A47B 49/008

(57) ABSTRACT

A skateboard storage assembly includes a storage housing that includes an access opening extending into an interior of the storage housing for having a skateboard extended therethrough. A door is hingedly coupled to the storage housing and the door is aligned with the access opening for opening and closing the access opening. A locking unit is coupled to the storage housing to lock the door. A carousel is rotatably positioned within the storage housing and the carousel has a plurality of storage spaces each integrated therein to receive a skateboard for storage. A dispensing unit is integrated into the storage housing for controlling the carousel to facilitate the user to either insert or remove their skateboard from the respective storage space.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to storage devices and more particularly pertains to a new storage device for storing a skateboard at a public building.

### (2) Description of Related Art Including Information Disclosed Under 37 CFR 1.97 and 1.98

The prior art relates to storage devices including a variety of electronic locker devices for storing personal items. The prior art also discloses a variety of lock boxes for storing a skateboard.

### BRIEF SUMMARY OF THE INVENTION

An embodiment of the disclosure meets the needs presented above by generally comprising a storage housing that includes an access opening extending into an interior of the storage housing for having a skateboard extended therethrough. A door is hingedly coupled to the storage housing and the door is aligned with the access opening for opening and closing the access opening. A locking unit is coupled to the storage housing to lock the door. A carousel is rotatably positioned within the storage housing and the carousel has a plurality of storage spaces each integrated therein to receive a skateboard for storage. A dispensing unit is integrated into the storage housing for controlling the carousel to facilitate the user to either insert or remove their skateboard from the respective storage space.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a skateboard storage assembly according to an embodiment of the disclosure.

FIG. 2 is a front view of an embodiment of the disclosure.

FIG. 3 is a back phantom view of an embodiment of the disclosure.

FIG. 4 is a right side phantom view of an embodiment of the disclosure.

FIG. 5 is a top view of an embodiment of the disclosure.

FIG. 6 is a perspective view of a carousel of an embodiment of the disclosure.

FIG. 7 is an exploded perspective view of a carousel and a cover of an embodiment of the disclosure.

FIG. 8 is a schematic view of an embodiment of the disclosure.

### DETAILED DESCRIPTION OF THE INVENTION

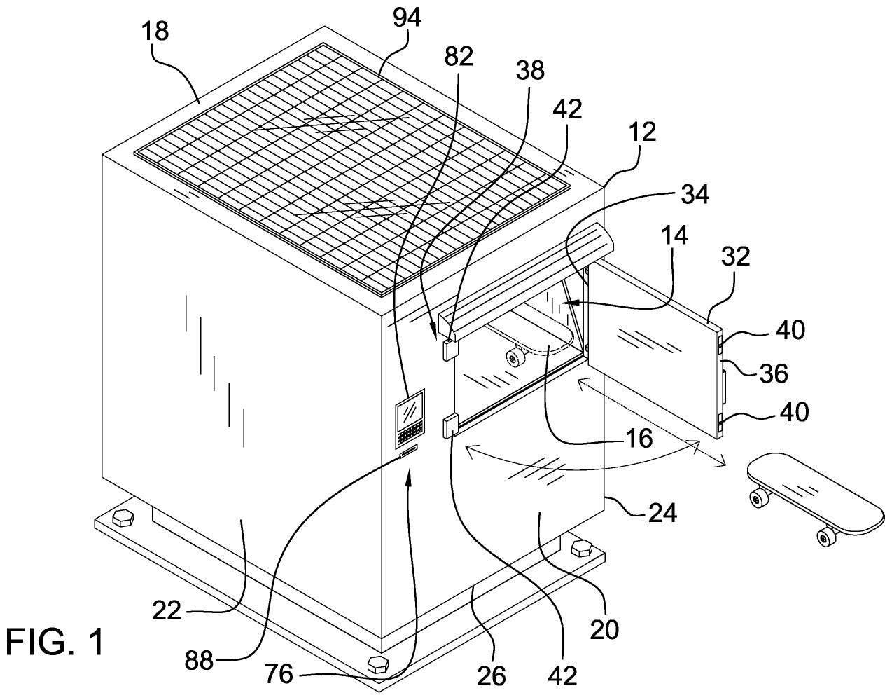

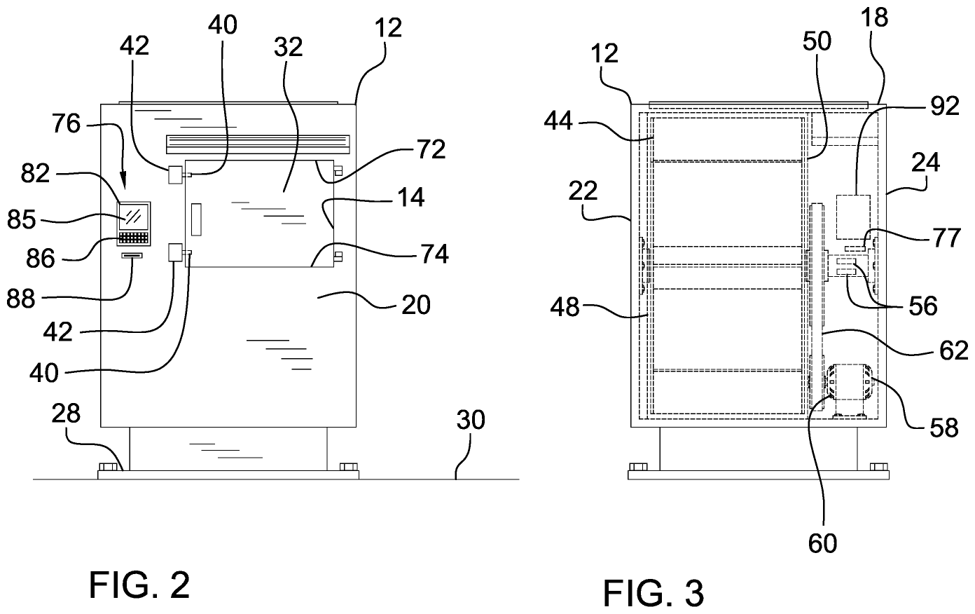

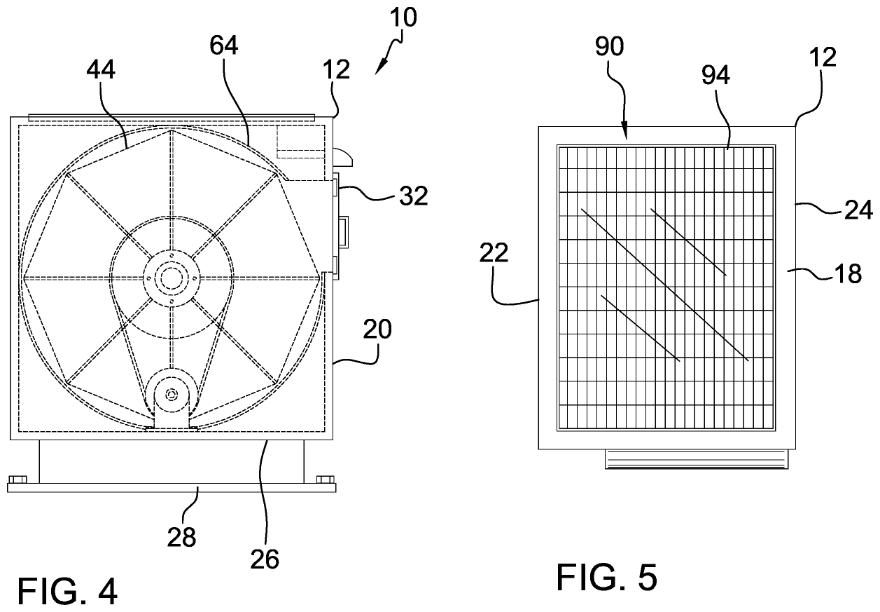

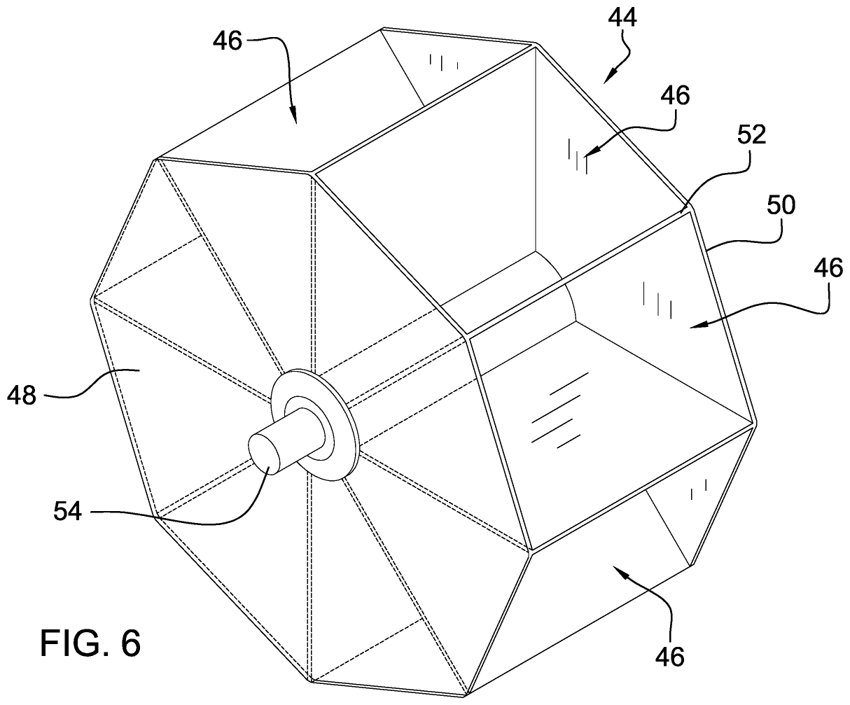

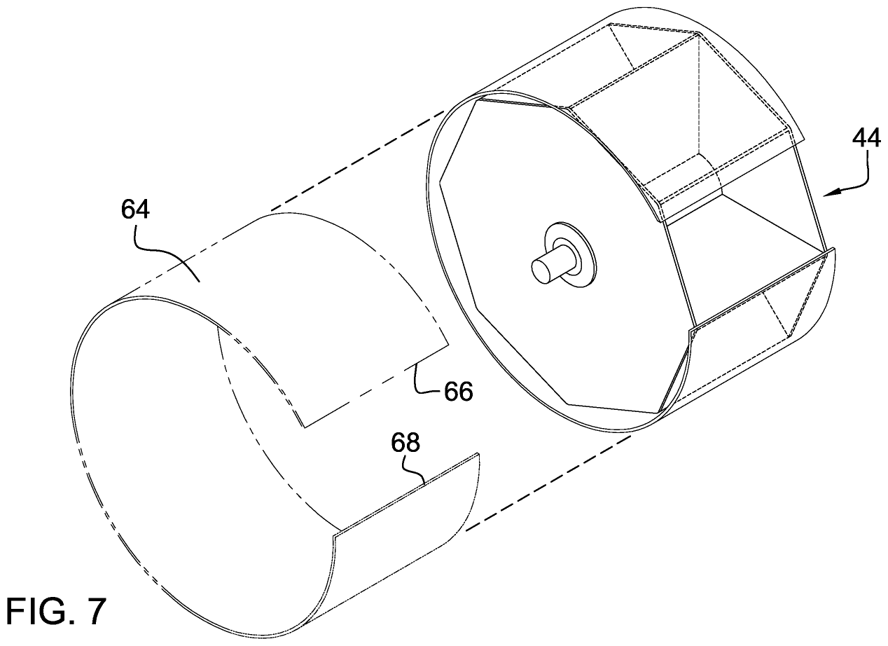

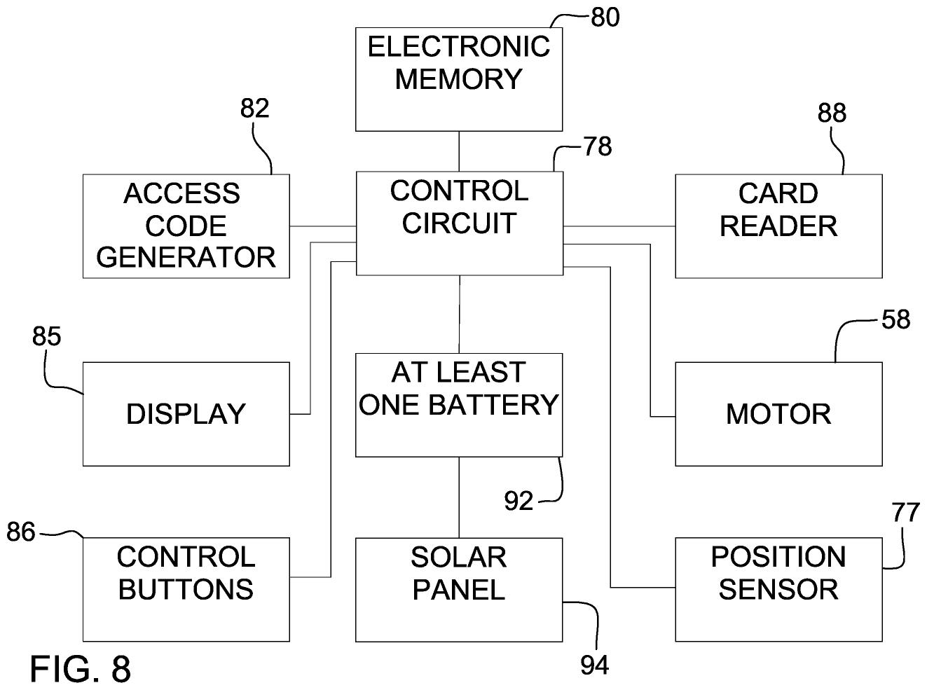

With reference now to the drawings, and in particular to FIGS. 1 through 8 thereof, a new storage device embodying the principles and concepts of an embodiment of the disclosure and generally designated by the reference numeral 10 will be described.

As best illustrated in FIGS. 1 through 8, the skateboard storage assembly 10 generally comprises a storage housing 12 that is positionable adjacent to a public building such that the storage housing 12 is accessible to patrons of the public building. The public building may be a library, a museum, a public school or any other type of public building. The storage housing 12 includes an access opening 14 extending into an interior of the storage housing 12 for having a skateboard 16 being extended therethrough. The storage housing 12 has a top wall 18, a front wall 20, a first lateral wall 22, a second lateral wall 24 and a bottom wall 26, and the front wall 20 has the access opening 14 extending therethrough. A base 28 is attached to the bottom wall 26 of the storage housing 12 and the base 28 is attached to a support surface 30 to inhibit the storage housing 12 from is removed from the public building. A door 32 is hingedly coupled to the storage housing 12 and the door 32 is aligned with the access opening 14 for opening and closing the access opening 14.

The door 32 has a first edge 34 and a second edge 36, and the first edge 34 is hingedly coupled to the front wall 20 of the storage housing 12. A locking unit 38 is provided and the locking unit 38 is coupled to the storage housing 12. The locking unit 38 is actuatable into a locking condition having the locking unit 38 engaging the door 32 when the door 32 is in a closed position thereby inhibiting the door 32 from being opened. The locking unit 38 is actuatable into an unlocked condition having the locking unit 38 disengaging the door 32 when the door 32 is in an open position thereby facilitating the door 32 to be opened.

The locking unit 38 comprises a pair of engagements 40 that is each coupled to the second edge 36 of the door 32. Each of the engagements 40 may comprise a ferromagnetic plate or the like. The locking unit 38 includes a pair of locks 42 and each of the locks 42 is coupled to the front wall 20 of the storage housing 12. Each of the locks 42 is positioned adjacent to the access opening 14 in the front wall 20. Each of the engagements 40 is aligned with a respective one of the locks 42 when the door 32 is in the closed position. Each of the engagements 40 is releasably engaged by the respective lock 42 when the locks 42 are turned on and each of the engagements 40 is disengaged by the respective lock 42 when the locks 42 are turned off. Each of the locks 42 may comprise electromagnetic locks or the like that can magnetically engage each of the engagements 40.

A carousel 44 is provided and the carousel 44 is rotatably positioned within the storage housing 12. The carousel 44 has a plurality of storage spaces 46 each being integrated therein. The carousel 44 is aligned with the access opening 14 in the storage housing 12 to receive the skateboard 16, a scooter or any other similarly sized transportation device for storage. The carousel 44 has a first lateral side 48, a second lateral side 50 and an outer side 52 extending therebetween, and the outer side 52 is continuously arcuate about a center point of the carousel 44 such that the carousel 44 has a drum shape. Each of the storage spaces 46 extends into the outer side 52 and the storage spaces 46 are distributed around a full circumference of the outer side 52.

A carousel shaft 54 extends through the first lateral side 48 and the second lateral side 50 of the carousel 44. The carousel shaft 54 rotatably engages each of the first lateral wall 22 and the second lateral wall 24 of the storage housing 12. Each of the storage spaces 46 in the outer side 52 of the carousel 44 is aligned with the access opening 14 as the carousel shaft 54 is rotated to facilitate access to the skateboard 16 stored in each of the storage spaces 46. Each of the storage spaces 46 is assigned a unique identity with respect to each other. Moreover, the carousel shaft 54 has a plurality of markers 56 integrated therein, each of the markers 56 is aligned with a respective one of the storage spaces 46 and each of the markers 56 is associated with the unique identity of the respective storage space 46.

A motor 58 is positioned within the housing 12, the motor 58 rotates in a first direction when the motor 58 is turned on and the motor 58 has an output shaft 60. The motor 58 may comprise an electric motor or the like. A belt 62 is wrapped around the output shaft 60 of the motor 58 and the carousel shaft 54 such that the carousel 44 is rotated when the motor 58 is turned on. A cover 64 is provided that has a first end 66, a second end 68 and a first surface 70 extending therebetween. The cover 64 is elongated between the first end 66 and the second end 68 and the cover 64 is wrapped around the outer side 52 of the carousel 44 having the first end 66 being spaced from the second end 68. Each of the first end 66 and the second end 68 is aligned with a respective top edge 72 and bottom edge 74 of the access opening 14 in the front wall 20 of the storage housing 12.

A dispensing unit 76 is integrated into the storage housing 12 and the dispensing unit 76 can be manipulated by a user. The dispensing unit 76 is in communication with the carousel 44 and the carousel 44 is rotated to align a respective one of the storage spaces 46 with the access opening 14 in the storage housing 12 when the dispensing unit 76 is actuated by the user. In this way the dispensing unit 76 facilitates the user to either insert or remove their skateboard 16 from the respective storage space 46. The dispensing unit 76 comprises a position sensor 77 that is integrated into the storage housing 12 and the position sensor 77 is aligned with the carousel shaft 54. The position sensor 77 senses each of the markers 56 as the carousel shaft 54 is rotated. The position sensor 77 may comprise an electronic position sensor or the like that is capable of electronically detecting each of the markers 56.

The dispensing unit 76 includes a control circuit 78 that is integrated into the storage housing 12. The position sensor 77 is electrically coupled to the control circuit 78 and the motor 58 is electrically coupled thereto. The control circuit 78 receives a load input and the control circuit 78 receives a dispense input. Moreover, the motor 58 is turned on when the control circuit 78 receives the dispense input. The dispensing unit 76 includes an electronic memory 80 that is integrated into the storage housing 12. The electronic memory 80 stores the unique identity of each of the storage spaces 46 and the electronic memory 80 is electrically coupled to the control circuit 78.

The dispensing unit 76 includes an access code generator 82 that is integrated into the housing 12. The access code generator 82 is electrically coupled to the control circuit 78 and the access code generator 82 generates a unique access code when the control circuit 78 receives the load input. The access code generator 82 may be an electronic code generator and the access code may be an alphanumeric code. The dispensing unit 76 includes a control panel 84 that is coupled to the front wall 20 of the storage housing 12 to be accessible to the user. The control panel 84 is electrically coupled to the control circuit 78 and the control panel 84 includes a display 85 and a plurality of control buttons 86. Each of the control buttons 86 is manipulated to facilitate the user to either store or retrieve their skateboard 16.

The display 85 displays indicia comprising operational data to facilitate the user to either store or retrieve their skateboard 16. The control circuit 78 receives the load input when the control panel 84 is manipulated thereby facilitating a respective storage space 46 to be aligned with the access opening 14. The electronic memory 80 stores the access code generated by the access code generator 82 and associates the access code with the respective storage space 46 that is aligned with the access opening 14. Each of the locks 42 is turned off when the control circuit 78 receives the load input to facilitate the user to insert their skateboard 16 into the respective storage space 46.

The control buttons 86 are manipulated to enter the access code when the skateboard 16 in the respective storage space 46 is to be retrieved from the carousel 44. The control circuit 78 receives the dispense input when the access code is entered with the control buttons 86 that corresponds to an access code stored in the electronic memory 80. The motor 58 is turned on to rotate the carousel 44 such that the storage space 46 with the unique identity that is associated with the access code entered with the control buttons 86 is aligned with the access opening 14 for retrieving the skateboard 16 from the carousel 44. Moreover, each of the locks 42 is turned off to facilitate the door 32 to be opened for removing the skateboard 16 from the storage housing 12.

The dispensing unit 76 includes a card reader 88 that is integrated into the storage housing 12 for having an electronic payment card inserted therein. The card reader 88 is electrically coupled to the control circuit 78 for processing payment for renting one of the storage spaces 46 in the carousel 44. The card reader 88 may be an electronic credit card reader 88 or the like and the electronic payment card may be a credit card or a debit card.

A power supply 90 is integrated into the housing 12 and the power supply 90 is electrically coupled to the control circuit 78. The power supply 90 comprises at least one battery 92 that is positioned in the storage housing 12. The at least one battery 92 is electrically coupled to the control circuit 78. The power supply 90 includes a solar panel 94 that is coupled to the top wall 18 of the storage housing 12 such that the solar panel 94 is exposed to sunlight. The solar panel 94 is electrically coupled to the at least one battery 92 for charging the at least one battery 92.

In use, the user inserts the electronic payment card into the card reader 88 to pay for renting storage time in the storage housing 12. The carousel 44 is rotated to align an empty storage space 46 with the access opening 14 and the locks 42 are turned off to facilitate the door 32 to be opened. The skateboard 16 is inserted into the carousel 44 and the access code is displayed on the display 85 for the user to memorize. The door 32 is closed and the locks 42 are turned on the secure the skateboard 16. The user enters the access code with the control buttons 86 to retrieve the skateboard 16 from the carousel 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A skateboard storage assembly for storing and subsequently dispensing user's skateboards or other personal transportation devices in a public setting, said assembly comprising:
a storage housing being positionable adjacent to a public building wherein said storage housing is configured to be accessible to patrons of the public building, said storage housing including an access opening extending into an interior of said storage housing wherein said access opening is configured to have a skateboard extended therethrough;
a door being hingedly coupled to said storage housing, said door being aligned with said access opening for opening and closing said access opening;
a locking unit being coupled to said storage housing, said locking unit being actuatable into a locking condition having said locking unit engaging said door when said door is in a closed position thereby inhibiting said door from being opened, said locking unit being actuatable into an unlocked condition having said locking unit disengaging said door when said door is in an open position thereby facilitating said door to be opened;
a carousel being rotatably positioned within said storage housing, said carousel having a plurality of storage spaces each being integrated therein, said carousel being aligned with said access opening in said storage housing wherein each of said storage spaces in said carousel is configured to receive a skateboard for storage; and
a dispensing unit being integrated into said storage housing wherein said dispensing unit is configured to be manipulated by a user, said dispensing unit being in communication with said carousel, said carousel being rotated to align a respective one of said storage spaces with said access opening in said storage housing when said dispensing unit is actuated by the user wherein said dispensing unit is configured to facilitate the user to either insert or remove their skateboard from said respective storage space.

2. The assembly according to claim 1, wherein:
said storage housing having a top wall, a front wall, a first lateral wall, a second lateral wall and a bottom wall, said front wall having said access opening extending therethrough; and
said assembly includes a base being attached to said bottom wall of said storage housing, said base being attached to a support surface wherein said base is configured to inhibit said storage housing from being removed from the public building.

3. The assembly according to claim 2, wherein:
said door has a first edge and a second edge, said first edge being hingedly coupled to said front wall of said storage housing; and
said locking unit comprises:
a pair of engagements, each of said engagements being coupled to said second edge of said door; and
a pair of locks, each of said locks being coupled to said front wall of said storage housing, each of said locks being positioned adjacent to said access opening in said front wall, each of said engagements being aligned with a respective one of said locks when said door is in said closed position, each of said engagements being releasably engaged by said respective lock when said locks are turned on, each of said engagements being disengaged by said respective lock when said locks are turned off.

4. The assembly according to claim 1, wherein said carousel has a first lateral side, a second lateral side and an outer side extending therebetween, said outer side being continuously arcuate about a center point of said carousel such that said carousel has a drum shape, each of said storage spaces extending into said outer side, said storage spaces being distributed around a full circumference of said outer side.

5. The assembly according to claim 4, further comprising a carousel shaft extending through said first lateral side and said second lateral side of said carousel, said carousel shaft rotatably engaging each of a first lateral wall and a second lateral wall of said storage housing, each of said storage spaces in said outer side of said carousel being aligned with said access opening as said carousel shaft is rotated wherein said carousel is configured to facilitate access to the skateboard stored in each of said storage spaces.

6. The assembly according to claim 5, wherein each of said storage spaces being assigned a unique identity with respect to each other, said carousel shaft having a plurality of markers being integrated therein, each of said markers being aligned with a respective one of said storage spaces, each of said markers being associated with said unique identity of said respective storage space.

7. The assembly according to claim 5, further comprising:
a motor being positioned within said housing, said motor rotating in a first direction when said motor is turned on, said motor having an output shaft; and
a belt being wrapped around said output shaft of said motor and said carousel shaft such that said carousel is rotated when said motor is turned on.

8. The assembly according to claim 4, further comprising a cover having a first end, a second end and a first surface extending therebetween, said cover being elongated between said first end and said second end, said cover being wrapped around said outer side of said carousel having said first end being spaced from said second end, each of said first end and said second end being aligned with a respective top edge and bottom edge of said access opening in said storage housing.

9. The assembly according to claim 5, wherein said dispensing unit comprises a position sensor being integrated into said storage housing, said position sensor being aligned with said carousel shaft, said position sensor sensing each of said markers as said carousel shaft is rotated.

10. The assembly according to claim 9, wherein said dispensing unit includes a control circuit being integrated into said storage housing, said position sensor being electrically coupled to said control circuit, said control circuit having said motor being electrically coupled thereto, said control circuit receiving a load input, said control circuit receiving a dispense input, said motor being turned on when said control circuit receives said dispense input or said load input.

11. The assembly according to claim 10, wherein said dispensing unit includes an electronic memory being integrated into said storage housing, said electronic memory storing the unique identity of each of said storage spaces, said electronic memory being electrically coupled to said control circuit.

12. The assembly according to claim 10, wherein said dispensing unit includes an access code generator being integrated into said housing, said access code generator being electrically coupled to said control circuit, said access code generator generating a unique access code when said control circuit receives said load input.

13. The assembly according to claim 10, wherein said dispensing unit includes a control panel being coupled to said front wall of said storage housing wherein said control panel is configured to be accessible to the user, said control panel being electrically coupled to said control circuit, said control panel including a display and a plurality of control buttons, each of said control buttons being manipulated to facilitate the user to either store or retrieve their skateboard, said display displaying indicia comprising operational data to facilitate the user to either store or retrieve their skateboard.

14. The assembly according to claim 13, wherein:
said dispensing unit includes an electronic memory being integrated into said storage housing;
said dispensing unit includes an access code generator;
said control circuit receives said load input when said control panel is manipulated thereby facilitating a respective storage space to be aligned with said access opening, said electronic memory storing said access code generated by said access code generator and associating said access code with said respective storage space that is aligned with said access opening, each of said locks being turned off when said control circuit receives said load input wherein said door is configured to facilitate the user to insert their skateboard into said respective storage space.

15. The assembly according to claim 14, wherein:
said dispensing unit includes a motor: and
said control buttons are manipulated to enter the access code when the skateboard in said respective storage space is to be retrieved from said carousel, said control circuit receiving said dispense input when said access code is entered with said control buttons that corresponds to an access code stored in said electronic memory, said motor being turned on to rotate said carousel such that said storage space with said unique identity that is associated with said access code entered with said control buttons is aligned with said access opening for retrieving the skateboard from said carousel.

16. The assembly according to claim 10, wherein said dispensing unit includes a card reader being integrated into said storage housing wherein said card reader is configured to have an electronic payment card inserted therein, said card reader being electrically coupled to said control circuit for processing payment for renting one of said storage spaces in said carousel.

17. The assembly according to claim 10, further comprising a power supply being integrated into said housing, said power supply being electrically coupled to said control circuit, said power supply comprising:
at least one battery being positioned in said storage housing, said at least one battery being electrically coupled to said control circuit; and
a solar panel being coupled to a top wall of said storage housing wherein said solar panel is configured to be exposed to sunlight, said solar panel being electrically coupled to said at least one battery for charging said at least one battery.

18. A skateboard storage assembly for storing and subsequently dispensing user's skateboards or other personal transportation devices in a public setting, said assembly comprising:
a storage housing being positionable adjacent to a public building wherein said storage housing is configured to be accessible to patrons of the public building, said storage housing including an access opening extending into an interior of said storage housing wherein said access opening is configured to have a skateboard extended therethrough, said storage housing having a top wall, a front wall, a first lateral wall, a second lateral wall and a bottom wall, said front wall having said access opening extending therethrough;
a base being attached to said bottom wall of said storage housing, said base being attached to a support surface wherein said base is configured to inhibit said storage housing from being removed from the public building:
a door being hingedly coupled to said storage housing, said door being aligned with said access opening for opening and closing said access opening, said door having a first edge and a second edge, said first edge being hingedly coupled to said front wall of said storage housing;
a locking unit being coupled to said storage housing, said locking unit being actuatable into a locking condition having said locking unit engaging said door when said door is in a closed position thereby inhibiting said door from being opened, said locking unit being actuatable into an unlocked condition having said locking unit disengaging said door when said door is in an open position thereby facilitating said door to be opened, said locking unit comprising:
a pair of engagements, each of said engagements being coupled to said second edge of said door; and
a pair of locks, each of said locks being coupled to said front wall of said storage housing, each of said locks being positioned adjacent to said access opening in said front wall, each of said engagements being aligned with a respective one of said locks when said door is in said closed position, each of said engagements being releasably engaged by said respective lock when said locks are turned on, each of said engagements being disengaged by said respective lock when said locks are turned off;
a carousel being rotatably positioned within said storage housing, said carousel having a plurality of storage spaces each being integrated therein, said carousel being aligned with said access opening in said storage housing wherein each of said storage spaces in said carousel is configured to receive a skateboard for storage, said carousel having a first lateral side, a second lateral side and an outer side extending therebetween, said outer side being continuously arcuate about a center point of said carousel such that said carousel has a drum shape, each of said storage spaces extending into said outer side, said storage spaces being distributed around a full circumference of said outer side;
a carousel shaft extending through said first lateral side and said second lateral side of said carousel, said carousel shaft rotatably engaging each of said first lateral wall and said second lateral wall of said storage housing, each of said storage spaces in said outer side of said carousel being aligned with said access opening as said carousel shaft is rotated wherein said carousel is configured to facilitate access to the skateboard stored in each of said storage spaces, each of said storage spaces being assigned a unique identity with respect to each other, said carousel shaft having a plurality of markers being integrated therein, each of said markers being aligned with a respective one of said storage spaces, each of said markers being associated with said unique identity of said respective storage space;
a motor being positioned within said housing, said motor rotating in a first direction when said motor is turned on, said motor having an output shaft;
a belt being wrapped around said output shaft of said motor and said carousel shaft such that said carousel is rotated when said motor is turned on;
a cover having a first end, a second end and a first surface extending therebetween, said cover being elongated between said first end and said second end, said cover being wrapped around said outer side of said carousel having said first end being spaced from said second end, each of said first end and said second end being aligned with a respective top edge and bottom edge of said access opening in said front wall of said storage housing; and
a dispensing unit being integrated into said storage housing wherein said dispensing unit is configured to be manipulated by a user, said dispensing unit being in communication with said carousel, said carousel being rotated to align a respective one of said storage spaces with said access opening in said storage housing when said dispensing unit is actuated by the user wherein said dispensing unit is configured to facilitate the user to either insert or remove their skateboard from said respective storage space, said dispensing unit comprising:
a position sensor being integrated into said storage housing, said position sensor being aligned with said carousel shaft, said position sensor sensing each of said markers as said carousel shaft is rotated;
a control circuit being integrated into said storage housing, said position sensor being electrically coupled to said control circuit, said control circuit having said motor being electrically coupled thereto, said control circuit receiving a load input, said control circuit receiving a dispense input, said motor being turned on when said control circuit receives said dispense input;
an electronic memory being integrated into said storage housing, said electronic memory storing the unique identity of each of said storage spaces, said electronic memory being electrically coupled to said control circuit;
an access code generator being integrated into said housing, said access code generator being electrically coupled to said control circuit, said access code generator generating a unique access code when said control circuit receives said load input;
a control panel being coupled to said front wall of said storage housing wherein said control panel is configured to be accessible to the user, said control panel being electrically coupled to said control circuit, said control panel including a display and a plurality of control buttons, each of said control buttons being manipulated to facilitate the user to either store or retrieve their skateboard, said display displaying indicia comprising operational data to facilitate the user to either store or retrieve their skateboard, said control circuit receiving said load input when said control panel is manipulated thereby facilitating a respective storage space to be aligned with said access opening, said electronic memory storing said access code generated by said access code generator and associating said access code with said respective storage space that is aligned with said access opening, each of said locks being turned off when said control circuit receives said load input wherein said door is configured to facilitate the user to insert their skateboard into said respective storage space, said control buttons being manipulated to enter the access code when the skateboard in said respective storage space is to be retrieved from said carousel, said control circuit receiving said dispense input when said access code is entered with said control buttons that corresponds to an access code stored in said electronic memory, said motor being turned on to rotate said carousel such that said storage space with said unique identity that is associated with said access code entered with said control buttons is aligned with said access opening for retrieving the skateboard from said carousel; and
a card reader being integrated into said storage housing wherein said card reader is configured to have an electronic payment card inserted therein, said card reader being electrically coupled to said control circuit for processing payment for renting one of said storage spaces in said carousel; and
a power supply being integrated into said housing, said power supply being electrically coupled to said control circuit, said power supply comprising:
at least one battery being positioned in said storage housing, said at least one battery being electrically coupled to said control circuit; and
a solar panel being coupled to said top wall of said storage housing wherein said solar panel is configured to be exposed to sunlight, said solar panel being electrically coupled to said at least one battery for charging said at least one battery.
